(19) United States
(12) Patent Application Publication
(10) Pub. No.: US 2010/0330535 A1
(43) Pub. Date: Dec. 30, 2010

(54) Chemo-mechanical Polishing of Dentures

(75) Inventors: Prasad Adusimilli, Parsippany, NJ (US); Stanley J. Lech, Parsippany, NJ (US); Zvi G. Loewy, Parsippany, NY (US)

Correspondence Address: GlaxoSmithKline;GLOBAL PATENTS -US, UW2220, P. O. BOX 1539, KING OF PRUSSIA, PA, 19406-0939, US

(73) Assignee: SMITHKLINE BEECHAM CORPORATION, PHILADELPHIA, PA (US)

(21) Appl. No.: 12/918,344

(22) PCT Filed: Feb. 20, 2009
(86) PCT No.: PCT/US09/34715

§ 371 Date: Aug. 19, 2010

(30) Foreign Application Priority Data
Feb. 22, 2008 (US) 61030834

(51) Int. Cl. A61C 13/20; B08B 3/00

(52) U.S. Cl. 433/199.1; 134/28

(57) ABSTRACT

This disclosure relates to a composition and method for cleaning and polishing dentures during denture fabrication.

### BACKGROUND OF THE INVENTION

1. Field of the Invention

The present disclosure relates to compositions and methods for cleaning and polishing dentures during denture fabrication. More particularly, the present disclosure is directed to compositions for dissolving a stone denture cast, and methods for polishing the denture.

2. Description of the Related Art

Full or partial dentures are intended to be worn in the mouth to replace missing teeth. Typically, a denture is fabricated using a cast or model that has a liquid or slurry cast material disposed therein. Once the denture is fully fabricated, it must be removed from this cast or model. Currently, the denture is removed from the cast by chipping away the hardened cast material. At this point, the denture contains a very rough surface with bits and pieces of cast material stuck to many areas of the denture. The denture is sand blasted using walnut chips to remove all residual material, a process that can take about 15 to 30 minutes. The denture is then polished on a rotating polishing wheel using pumice rock as the polishing medium and thereafter a cloth wheel to obtain the final polished denture. This process can take about 30 to 60 minutes.

These are very tedious and time-consuming processes. Accordingly, there is a need for a more efficient method for removing dentures from stone casts, and for polishing the dentures after they are removed.

### SUMMARY OF THE INVENTION

The present disclosure provides compositions and methods for cleaning and polishing dentures during the manufacturing process. The disclosure establishes a significantly simplified process, which is more reproducible, faster and cheaper, while maintaining or enhancing the quality of the denture manufacturing process.

In one embodiment, the present disclosure provides a method for cleaning and polishing a denture formed within a cast material. The method comprises the steps of soaking the cast material containing the denture in a dissolution composition, to dissolve the cast material, removing the denture from the dissolution composition, and polishing the denture with a solvent composition.

In another embodiment, the present disclosure provides a method of producing and polishing a denture. The method comprises the steps of placing a wax model of the denture within a cast material that is in a liquid or slurry state, curing the cast material, melting the wax model to form a mold within the cured cast material, injecting a liquid material into the mold, curing the liquid material to form the denture, presenting the denture having an amount of the cured cast material disposed thereon to a device, and removing at least a portion of the cured cast material with the device. The method can further comprise presenting the denture having an amount of the cured cast material disposed thereon to a second device. The method can further comprise the steps of affixing the denture to a device, and polishing the denture with a pumice slurry using a robotic arm operably connected to the device.

### BRIEF DESCRIPTION OF THE DRAWINGS

FIG. 1 illustrates a denture being removed from a device containing the dissolution composition of the present disclosure;

FIG. 2 illustrates a dispensing device with a polishing cloth of the present disclosure;

FIG. 3 illustrates a wax model of the denture connected to wax sprues and a hollow tube, placed inside a cast with liquid or slurry cast material;

FIG. 4 shows the denture connected to a sprue, and in turn to the hollow tube, with cast material disposed on the denture;

FIG. 5 shows a robotic arm holding the denture against a mechanical cutting wheel to remove the cast material from around the denture;

FIG. 6 shows the robotic arm holding the denture against a cloth polishing wheel;

FIG. 7 shows the final polished denture with the acrylic sprues and the channel intact; and

FIG. 8 illustrates a device having a robotic arm and a substrate disposed thereon for polishing the denture.

### DETAILED DESCRIPTION OF THE DISCLOSURE

The term “denture(s)” as used herein refers to full or complete dentures or partial dentures, artificial teeth, removable orthodontic bridges and denture plates, both upper and lower types, orthodontic retainers and appliances, protective mouthguards, and nightguards to prevent bruxism and/or temporomandibular joint (TMJ) disorder.

The present disclosure provides chemical compositions and methods for dissolving the cast material that is used to form the denture, and also to polish the denture after it is removed from the cast material. The cast material is first dissolved with a dissolution composition comprising a compound that is safe to the denture material. (The denture material is often an acrylic such as polymethyl methacrylate (PMMA)). The denture is then removed from the dissolution composition, washed and dried, and can then be polished with a second or solvent composition that is meant to dissolve a very small amount of the surface layer of the denture. As an alternative to the solvent composition, the denture can be placed in a device that has a robotic arm that polishes the denture using a substrate with a pumice slurry disposed thereon.

This method of removing the denture from the cast material, and polishing it, is thus advantageous over what has typically been used. The present method is much less tedious and time-consuming. There is no requirement that a person removing the denture from the cast chip away at the cast material, sandblast the denture to remove any fragments of the cast material that remain on the denture, or manually polish the denture with a pumice stone. In this method of the present disclosure, the cast material with the denture embedded therein is simply placed in the dissolution composition, and the operator or technician is free to perform other tasks while the cast material is dissolved. The solvent composition is also much easier to use than traditional, manual polishing methods that use a pumice stone.

In one embodiment, the dissolution composition comprises a weak or a strong acid that does not damage the denture surface. For example, citric acid, hydrochloric acid, nitric acid, sulfuric acid, acetic acid, phosphoric acid, formic acid, or any combinations thereof, can be used. The dissolution composition can also include carriers, such as water. The acid can be present in the dissolution composition in an amount of about 1 wt % to about 50 wt %, preferably 1 wt % to 50 wt %. In another embodiment, the acid can be present in the dissolution composition in an amount of about 10 wt % to about 40 wt %, preferably 10 wt % to 40 wt %. In another embodiment, the acid can be present in the dissolution composition in an amount of about 20 wt % to about 35 wt %, preferably 20 wt % to 35 wt %.

In another embodiment, instead of an acid, the dissolution composition can comprise compounds such as sodium carbonate, sodium chloride, sodium nitrite, barium chloride, or any combinations thereof. These compounds will also dissolve the cast material, and not harm the acrylic material of the denture. They can be present in the dissolution composition in an amount of about 5 wt % to about 50 wt %, preferably 5 wt % to 50 wt %. In another embodiment, they can be present in the dissolution composition in an amount of about 10 wt % to about 40 wt %, preferably 10 wt % to 40 wt %. In another embodiment, they can be present in the dissolution composition in an amount of about 20 wt % to about 30 wt %, preferably 20 wt % to 30 wt %.

The cast material containing the denture will be left to soak in the dissolution composition for an appropriate amount of time to allow the cast material to dissolve away. In one embodiment, the amount of time can be from five minutes, up until an hour. Again, even at higher dissolution times, this is a much easier method for removing the cast material than what has typically been used. The cast is simply placed in the dissolution composition, and left until the cast material is dissolved. The denture is then collected, washed with water and dried.

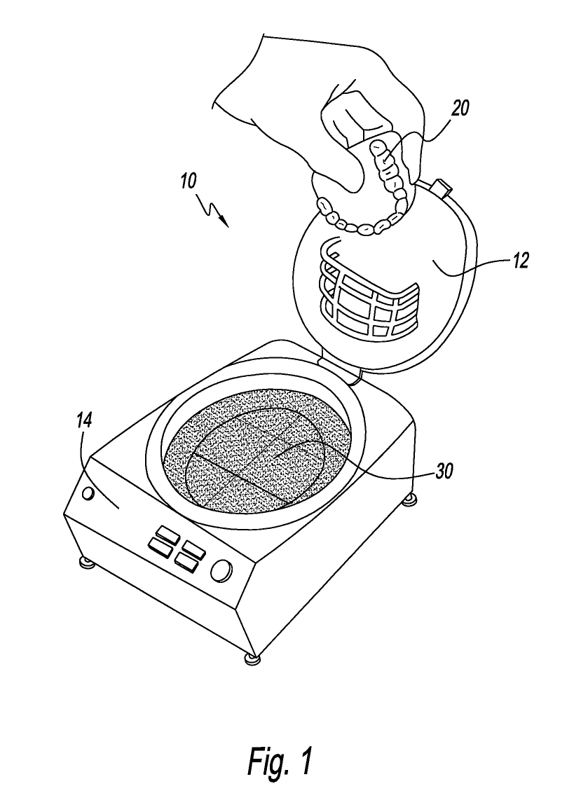

Referring to FIG. 1, an apparatus or device 10 for dissolving cast material (not shown) from denture 20 is shown. Apparatus 10 can contain dissolution composition 30. When lid 12 of apparatus 10 is closed, denture 20 is disposed within dissolution composition 30. Apparatus 10 can further have control panel 14 disposed on an outer face thereof. Using control panel 14, a user can set the amount of time that denture 20 will be in the dissolution composition 30. As previously discussed, this is a highly advantageous method for removing cast material from a denture over what is currently available, as the technician or operator will be free to perform other tasks.

In one embodiment of the present disclosure, the clean denture is then further polished using a solvent composition that is designed to dissolve and remove a very tiny surface layer of the denture. The surface layer that is removed by the solvent composition can be anywhere from 1 to 100 microns in thickness. This removal process results in a smooth, shiny, finish for the surface of the denture.

The solvent composition can have two components, namely an active solvent, and a carrier solvent. The active solvent is one that has a low level of solubility for the denture material, which as discussed above can be an acrylic such as PMMA. Suitable active solvents for the present disclosure include benzene, toluene, o-xylene, m-xylene, trichloromethane, trichloro ethylene, 1, 4 dioxane, cyclohexanone, acetophenone, ethyl acetate, pentyl acetate and dimethylformamide, or any combinations thereof. The solubility of these solvents in acrylic, expressed in grams of solute per milliliter of solvent, ranges from 0.3% for trichloromethane to 35.8% for trichloroethylene.

The selection of a suitable solvent is made based on the efficacy of the active solvent, miscibility with the carrier solvent, and the polish obtained on the final denture. The amount of active solvent in the solvent composition can be adjusted to provide the desired end result. The solvents with high solubility such as trichloroethylene can be used at a much lower level than solvents with low solubility such as trichloromethane in the solvent composition. The preferred active solvents in the solvent composition are the ones that provide the best finish on the final denture.

The carrier solvent should be miscible with the active solvent. The carrier solvent forms the bulk of the solvent composition, and facilitates delivery of the active solvent to the surface of the denture. Suitable carrier solvents include, but are not limited to, alcohol, for example ethanol, isopropyl alcohol, methanol, n-butanol, n-propanol, water, and any combinations thereof. The carrier solvent should have no solubility with respect to the denture material, i.e. acrylics such as PMMA.

In one embodiment, the active solvent is present in an amount of about 1 wt % to about 20 wt %, preferably 1 wt % to 20 wt %, of the solvent composition. In another embodiment, the active solvent is present in an amount of about 5 wt % to about 15 wt %, preferably 5 wt % to 15 wt %, of the solvent composition. In another embodiment, the active solvent is present in an amount of about 5 wt % to about 10 wt %, preferably 5 wt % to 10 wt %, of the solvent composition.

Alternatively, the solvent composition can comprise an engineered mixture of non-flammable hydrofluorocarbons and trans-1,2-dichloroethylene, which is sold commercially as Dupont Vertrel® SDG. The solvent composition can also comprise an azeotrope blend of 2,3-dihydrodecafluoropentane (sold commercially as Dupont Vertrel® XF) and trans-1,2-dichloroethylene and ethanol. The azeotrope blend of these compounds is sold commercially as Vertrel® C-HD by Dupont.

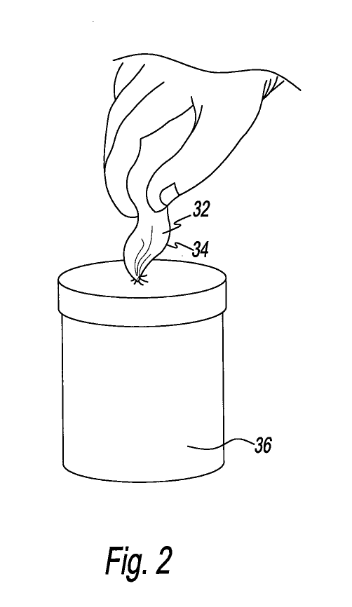

The polishing solvent composition can be deposited onto a piece of polishing cloth, for example, polyester, Tyvex or chamois. As shown in FIG. 2, a polishing cloth 32 can be impregnated with the solvent composition 34, and packaged in a dispenser 36 for ease of use, similar to wet napkins or wipes.

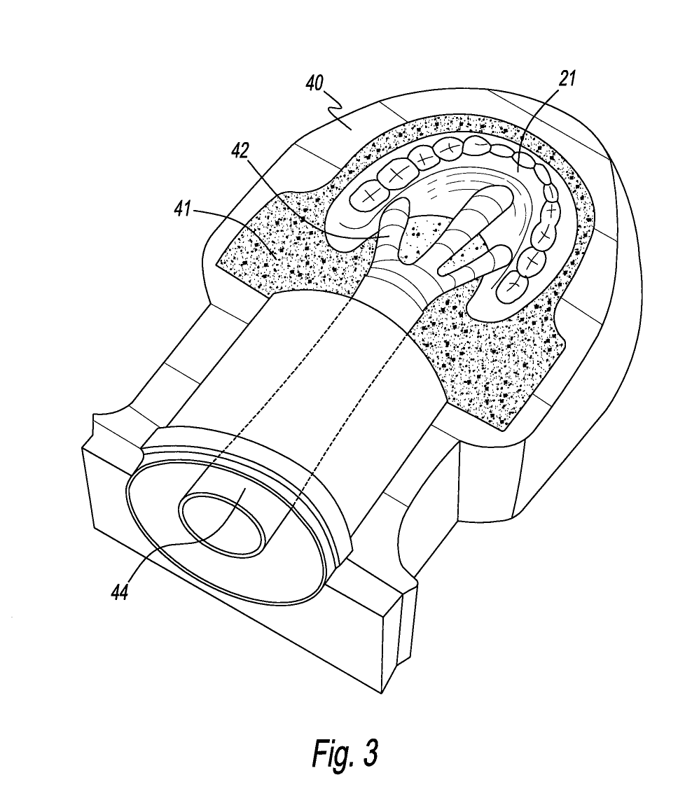

Referring to FIGS. 3-8, an alternative method of removing cast material from the denture 20 and polishing it is shown. As shown in FIG. 3, a wax model 21 that is formed in the shape of what will ultimately become denture 20 for the patient can be connected to or formed with a wax sprue 42, and in turn wax sprue 42 is connected to a hollow tube 44. Hollow tube 44 is then used to place wax model 21 and wax sprue into metal casing 40, which has cast material 41 disposed therein. At this point, cast material 41 is in a liquid or slurry state. Metal casing 40 can then be heated, which causes cast material 41 to harden and cure. The entire assembly, i.e. metal casing 40 having cast material 41, wax model 21, and wax sprue 42 disposed therein, is then heated to the point at which wax model 21 and wax sprue 42 will melt, and pour out through hollow tube 44, leaving a mold within the hardened cast material 41. At this point, a suitable liquid material for forming dentures, such as an acrylic like PMMA, is injected into the mold left by the melting away of wax model 21 and wax sprue 42.

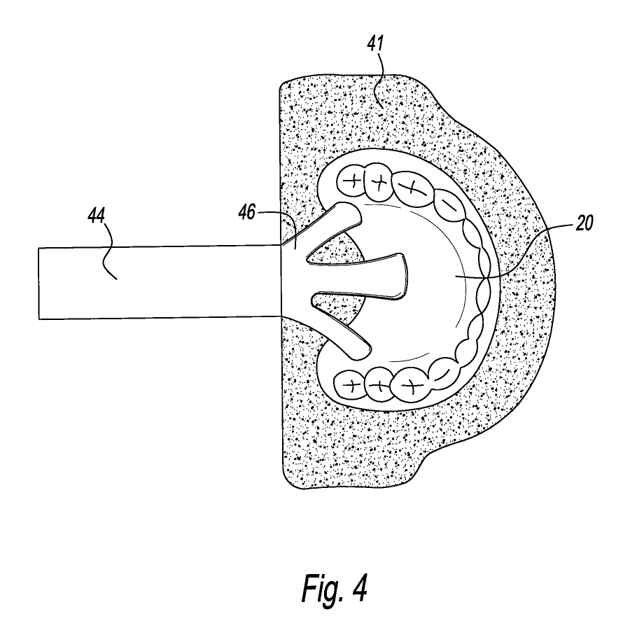

The liquid denture material is cured under heat within the mold, thus forming denture 20, and acrylic sprue 46. At this point, as shown in FIG. 4, metal casing 40 is removed, and hardened cast material 41, denture 20, and acrylic sprue 46 will adhere to each other.

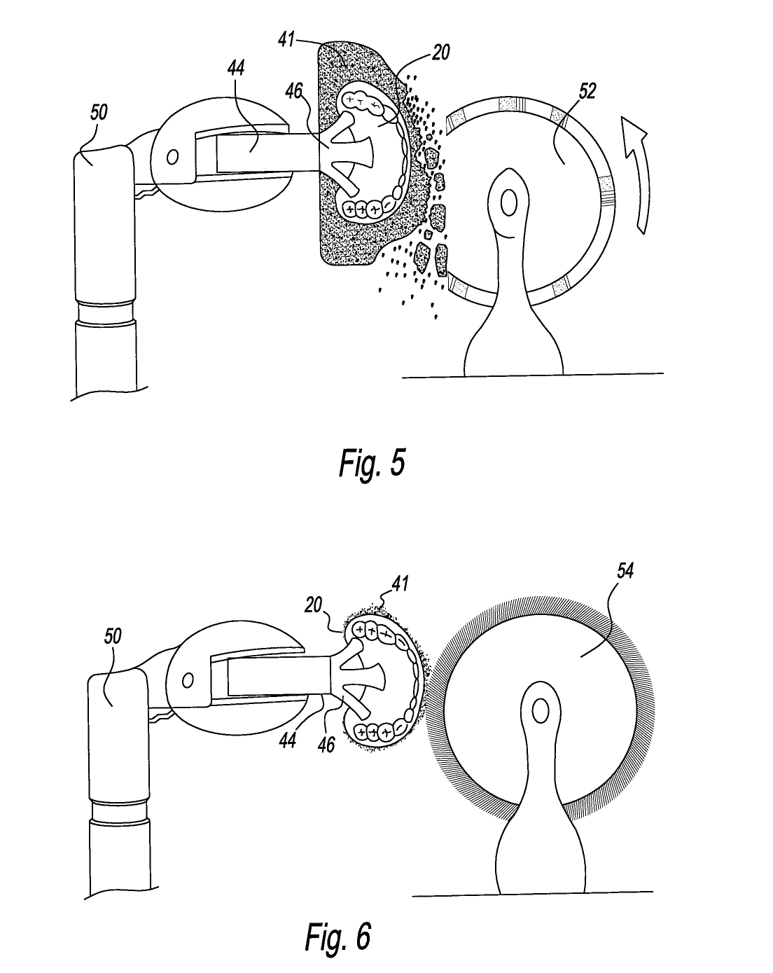

Referring to FIG. 5, hollow tube 44, having acrylic sprue 46 connected thereto, which in turn has denture 20 connected thereto or formed integrally therewith, can then be operably connected to a robotic arm 50. In an entirely automated process, the robotic arm 50 holds hollow tube 44 against a cutting wheel 52, or other suitable mechanical means of chipping away the cast material 41. In the embodiment shown in FIG. 5, cutting wheel 52 has a plurality of cutting teeth 53 disposed thereon. The parameters for duration of time and angles of presentation of the cast material 41 to the cutting wheel 52 can be preset to ensure proper removal of a large amount of cast material 41.

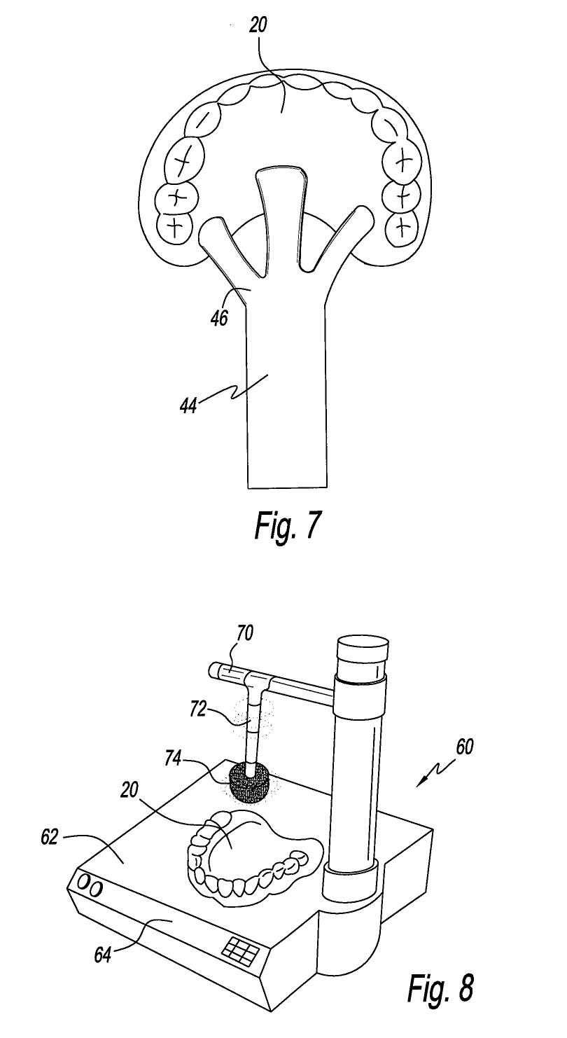

After a sufficient amount of large chunks of cast material 41 have been removed, there will still be a small layer, or bits and pieces, of cast material 41 left on denture 20. Robotic arm 50 can then present denture 20 to a buffing wheel 54, as shown in FIG. 6. Buffing wheel 54 will remove any remaining small fragments of cast material 41 that are still stuck to denture 20. Again, the parameters for duration of time and angles of presentation of denture 20 having cast material 41 disposed thereon to the buffing wheel 54 can be preset to ensure proper and complete removal of stone using mechanical methods. As shown in FIG. 7, after the buffing is complete, denture 20 will be free of cast material 41, and will be ready for polishing. Acrylic sprue 46 is cut away before denture 20 is polished.

After cast material 41 is removed from the denture 20, and after acrylic sprue 46 is removed, denture 20 can be polished with the solvent composition, as discussed above. Alternatively, as shown in FIG. 8, it can be placed on a platform 62 of polishing device 60, where it can be secured in place. Device 60 can have an automated robotic arm 70, which can have a second arm 72 operably connected thereto. Second arm 72 can have a buffing wheel or other substrate 74 connected to an end thereof. Device 60 delivers polishing agents such as pumice slurry to substrate 74, and then applies it to denture 20 for a set period of time, until denture 20 is sufficiently polished. Second arm 72 will follow preprogrammed instructions to hold substrate 74 against denture 20 for a set duration of time, at a set amount of pressure, and change the angles periodically over a duration of 2 to 15 minutes. This previously established protocol will ensure that the robotic system disclosed here consistently and reproducibly delivers highly polished dentures. Device 60 can also have a control panel 64, where a user can set the amount of time for which denture 20 is polished, the pressure at which to hold denture 20 against the buffing wheel, and the rotation of denture 20 at preset times to polish the denture on all sides.

The present disclosure contemplates combining either of the cast material removal methods discussed above with any of the polishing methods discussed above. For example, either the dissolution composition or the method using robotic arm 50 can be used to remove the cast material, and then either the solvent composition or device 60 can be used to polish the denture 20.

While the present disclosure discusses features in the singular case, it is understood that singular terms can also mean their plural equivalents where applicable. In addition, the present disclosure has been described with particular reference to certain embodiments. It should be understood that the foregoing descriptions and examples are only illustrative of the invention. Various alternatives and modifications thereof can be devised by those skilled in the art without departing from the spirit and scope of the present disclosure. Accordingly, the present disclosure is intended to embrace all such alternatives, modifications, and variations that fall within the scope of the appended claims.

What is claimed is:

1. A method for cleaning and polishing a denture formed within a cast material, comprising the steps of:
soaking the cast material containing the denture in a dissolution composition, to dissolve the cast material;
removing the denture from said dissolution composition; and
polishing the denture with a solvent composition.

2. The method of claim 1, wherein said dissolution composition comprises an acid, and a carrier.

3. The method of claim 2, wherein said acid is selected from the group consisting of citric acid, hydrochloric acid, nitric acid, sulfuric acid, acetic acid, phosphoric acid, formic acid and any combinations thereof.

4. The method of claim 2, wherein said acid is present in an amount of about 1 wt % to about 50 wt % of the dissolution composition.

5. The method of claim 4, wherein said acid is present in an amount of about 10 wt % to about 40 wt % of the dissolution composition.

6. The method of claim 1, wherein said dissolution composition comprises a compound selected from the group consisting of sodium carbonate, sodium chloride, sodium nitrite, barium chloride, and any combinations thereof.

7. The method of claim 6, wherein said compound is present in an amount of about wt % to about 50 wt % of the dissolution composition.

8. The method of claim 7, wherein said compound is present in an amount of about wt % to about 40 wt % of the dissolution composition.

9. The method of claim 1, wherein said solvent composition comprises an active solvent and a carrier solvent.

10. The method of claim 9, wherein said active solvent is selected from the group consisting of benzene, toluene, o-xylene, m-xylene, trichloromethane, trichloro ethylene, 1, 4 dioxane, cyclohexanone, acetophenone, ethyl acetate, pentyl acetate and dimethylformamide, and any combinations thereof.

11. The method of claim 9, wherein said active solvent is present in the solvent composition in an amount of about 1 wt % to about 20 wt %.

12. The method of claim 11, wherein said active solvent is present in the solvent composition in an amount of about 5 wt % to about 15 wt %.

13. The method of claim 9, wherein said carrier solvent is selected from the group consisting of ethanol, isopropyl alcohol, methanol, n-butanol, n-propanol, water and any combinations thereof.

14. The method of claim 1, wherein said solvent composition comprises an engineered mixture of non-flammable hydrofluorocarbons and trans-1,2-dichloroethylene.

15. The method of claim 1, wherein said solvent composition comprises an azeotrope blend of 2,3-dihydrodecafluoropentane and trans-1,2-dichloroethylene and ethanol.

16. A method of producing and polishing a denture, comprising:
placing a wax model of the denture within a cast material that is in a liquid or slurry state;
curing said cast material;
melting said wax model to form a mold within said cured cast material;
injecting a liquid material into said mold;
curing said liquid material to form the denture;
presenting the denture having an amount of said cured cast material disposed thereon to a device; and
removing at least a portion of said cured cast material with said device.

17. The method of claim 16, wherein said liquid material is an acrylic.

18. The method of claim 16, wherein the denture having an amount of said cured cast material disposed thereon is presented to said device by a robotic arm, wherein said robotic arm presents the denture to said device for a set amount of time, and at set angles of presentation.

19. The method of claim 18, wherein the device is a cutting wheel having a plurality of cutting teeth disposed thereon.

20. The method of claim 16, further comprising the steps of:
presenting the denture having an amount of said cured cast material disposed thereon to a second device.

21. The method of claim 20, wherein the denture having an amount of said cured cast material disposed thereon is presented to said second device by a robotic arm, wherein said robotic arm presents the denture to said second device for a set amount of time, and at set angles of presentation.

22. The method of claim 21, wherein said second device is a buffing wheel.

23. The method of claim 20, further comprising the steps of:
affixing the denture to a device;
polishing the denture with a pumice slurry using a robotic arm operably connected to said device.
